(19) United States
(12) Patent Application Publication
(10) Pub. No.: US 2014/0300941 A1
(43) Pub. Date: Oct. 9, 2014

(54) METHOD AND APPARATUS FOR GENERATING HOLOGRAM BASED ON MULTI-VIEW IMAGE

(71) Applicant: Electronics and Telecommunications Research Institute, Daejeon (KR)

(72) Inventors: Eun Young CHANG, Daejeon (KR); Kyung Ae MOON, Daejeon (KR); Jin Woong KIM, Daejeon (KR)

(73) Assignee: Electronics and Telecommunications Research Institute, Daejeon (KR)

(21) Appl. No.: 14/245,992

(22) Filed: Apr. 4, 2014

(30) Foreign Application Priority Data
Apr. 5, 2013 (KR) 10-2013-0037350

(51) Int. Cl. G03H 1/08

(52) U.S. Cl. CPC G03H 1/08
USPC 359/9

(57) ABSTRACT

Disclosed are a method and apparatus for generating a hologram based on a multi-view image. The method of generating a hologram image may include receiving a multi-view image and calculating depth information about an image at each view of the multi-view image, calculating an integrated 3-D space datum based on the multi-view image and the pieces of depth information, and generating hologram information from the integrated 3-D space datum. Accordingly, a natural 3-D image can be played because a 3-D image corresponding to an observer view is reproduced without a process of generating in-between view images and pieces of corresponding depth information when the observer moves.

This application claims the benefit of priority of Korean Patent Application No. 10-2013-0037350 filed on Apr. 5, 2013, which is incorporated by reference in its entirety herein.

### BACKGROUND OF THE INVENTION

1. Field of the Invention

The present invention relates to a method and apparatus for generating a three-dimensional image and, more particularly, to a method and apparatus for generating a hologram.

2. Discussion of the Related Art

As the three-dimensional (3-D) video industry and the 3-D display industry are recently being activated, active research is being carried out on holography technology known as a final 3-D imaging method.

In holography technology, information about the phase of an object is recorded by way of interference between two pieces of light (i.e., light waves) called a ‘reference wave’ and an ‘object wave’. When reference wave is thrown on to the interference pattern, a 3-D image can be reproduced. This holography technology has the most excellent characteristic in terms of a 3-D depth effect, etc. as compared with some other methods for implementing a 3-D image. In this holography technology, a 3-D image can be watched without a visual fatigue.

Existing analog holography technology is a method of throwing laser light onto a target object in a non-vibration darkroom environment, recording information about the wavelength and amplitude of the reflected light that appear through interference on a film, and representing a 3-D image by developing the film. The existing analog holography technology is problematic in that application fields thereof are limited due to limitations, such as that an object on which a laser can be thrown is limited and that a non-vibration darkroom environment must be provided.

By the help of digital technology and computing technology that have remarkably grown, digital holography technology that has departed from the existing analog method has appeared. A hologram can be produced even without using an optical method through a computer-generated hologram in which an interference phenomenon between an object wave and a reference wave is performed by way of computer simulations. In the computer-generated hologram technology, in order to generate a hologram by way of computer simulations, pieces of color information R, G, and B and pieces of 3-D space information X, Y, and Z for a target object or scene to be reproduced are used. In a prior art, computer graphics technology is chiefly used because 3-D space information (i.e., depth information) for a target object or scene can be easily obtained. Recently, however, research is being carried out on digital hologram generation technology based on an actual image in which 3-D space information (depth information) is obtained through a stereo image or a multi-view image.

Depth information about an image obtained using computer graphics technology and depth information about an image obtained using an actual image, such as a stereo image and a multi-view image, are related to a 3-D image regarding one fixed view. As a result, a hologram generated from the pieces of depth information reproduces a 3-D image for a fixed view. Accordingly, the hologram cannot reproduce a 3-D image depending on a varying observation location when an observer moves.

### SUMMARY OF THE INVENTION

An object of the present invention is to provide a method of generating a hologram based on a multi-view image.

Another object of the present invention is to provide an apparatus for performing the method of generating a hologram based on a multi-view image.

In accordance with an embodiment of the present invention, a method of generating a hologram image may include receiving a multi-view image and calculating depth information about an image at each view of the multi-view image, calculating an integrated 3-D space datum based on the multi-view image and the pieces of depth information, and generating hologram information from the integrated 3-D space datum. Receiving a multi-view image and calculating depth information about an image at each view of the multi-view image may include calculating first image information and first depth information generated at a first viewpoint, calculating second image information and second depth information generated at a second viewpoint, and calculating third image information and third depth information generated at a third viewpoint. Calculating an integrated 3-D space datum based on the multi-view image and the pieces of depth information may include converting the multi-view image for the each view into 3-D data based on the pieces of calculated depth information and calculating the integrated 3-D space datum that is integrated information of the each 3-D data for the respective views. Converting the multi-view image into 3-D data for the each view based on the pieces of calculated depth information may be determined by the following equation regarding a relationship between 3-D coordinates and 2-D coordinates of the projected image for a camera.

$$[ \begin{matrix}x \\ y \\ 1\end{matrix} ] = K [ R \vert T ] [ \begin{matrix}X \\ Y \\ Z \\ 1\end{matrix} ] \qquad 〈 Equation 〉$$

wherein x, y are the 2-D coordinates projected within an image plane, K is, a 3×3 matrix, a camera-intrinsic parameter, R is, a 3×3 matrix, a camera-extrinsic parameter for a rotation of the camera, T is, a 3×1 matrix, a camera-extrinsic parameter for a translation of the camera, and X, Y, and Z are coordinates on a 3-D space and indicate pieces of information about a width, height, and depth. Generating hologram information from the integrated 3-D space datum may be performed by the following equation.

$${I}_{α} = {\sum }_{j ∈ α}^{N} {A}_{j} cos [ k \sqrt{{( {px}_{α} - {x}_{j} )}^{2} + {( {py}_{α} - {y}_{j} )}^{2} + {z}_{j}^{2}} ] \qquad 〈 Equation 〉$$

wherein α is a pixel of a hologram, j is a 3-D object point, k is a wave number of a reference wave defined as 2π/λ, p is a pixel pitch of a hologram, x_{α} and y_{α} are coordinates of the hologram, xⱼ, yⱼ, and zⱼ indicate coordinates on a 3-D space of the 3-D object point, l_{α} indicates an light intensity of the hologram, and Aⱼ indicates a color component value of the 3-D object point. The method may further include calculating depth information using a depth camera.

In accordance with an embodiment of the present invention, an apparatus for generating a hologram image may include a depth information calculation unit configured to receive a multi-view image and calculating depth information about an image at each viewpoint of the multi-view image, a 3-D data integration unit configured to calculate an integrated 3-D space datum based on the multi-view image and the pieces of depth information, and a hologram generation unit configured to generate hologram information from the integrated 3-D space datum. The apparatus may further include a multi-view image acquisition unit configured to obtain pieces of image information generated at a first viewpoint, a second viewpoint, and a third viewpoint. The depth information calculation unit may be configured to calculate first image information and first depth information generated at the first viewpoint, calculate second image information and second depth information generated at the second viewpoint, and calculate third image information and third depth information generated at the third viewpoint. The apparatus may further include a 3-D data conversion unit configured to convert the multi-view image into 3-D data for the each view based on the pieces of calculated depth information. The 3-D data integration unit may be configured to calculate the integrated 3-D space datum that is integrated information of the 3-D data for the respective views. The 3-D data conversion unit may convert the multi-view image into 3-D data for the views based on the pieces of calculated depth information according to the following equation regarding a relationship between 3-D coordinates and 2-D coordinates of the projected image for a camera.

$$[ \begin{matrix}x \\ y \\ 1\end{matrix} ] = K [ R \vert T ] [ \begin{matrix}X \\ Y \\ Z \\ 1\end{matrix} ] \qquad 〈 Equation 〉$$

wherein x, y are the 2-D coordinates projected within an image plane, K is, a 3×3 matrix, a camera-intrinsic parameter, R is, a 3×3 matrix, a camera-extrinsic parameter for a rotation of the camera, T is, a 3×1 matrix, a camera-extrinsic parameter for a translation of the camera, and X, Y, and Z are coordinates on a 3-D space and indicate pieces of information about a width, height, and depth. The hologram generation unit may be configured to generate hologram information from the integrated 3-D space datum according to the following equation.

$${I}_{α} = {\sum }_{j ∈ α}^{N} {A}_{j} cos [ k \sqrt{{( {px}_{α} - {x}_{j} )}^{2} + {( {py}_{α} - {y}_{j} )}^{2} + {z}_{j}^{2}} ] \qquad 〈 Equation 〉$$

wherein α is a pixel of a hologram, j is a 3-D object point, k is a wave number of a reference wave defined as 2π/λ, p is a pixel pitch of a hologram, x_{α} and y_{α} are coordinates of the hologram, xⱼ, yⱼ, and zⱼ indicate coordinates on a 3-D space of the 3-D object point, l_{α} indicates an light intensity of the hologram, and Aⱼ indicates a color component value of the 3-D object point. The depth information may be a value calculated using depth camera.

### BRIEF DESCRIPTION OF THE DRAWINGS

FIG. 1 is a block diagram showing an apparatus for generating a digital hologram based on a multi-view image in accordance with a preferred embodiment of the present invention;

FIG. 2 is a conceptual diagram showing an obtained depth image in accordance with an embodiment of the present invention;

FIG. 3 is a conceptual diagram showing a method of converting 3-D data in accordance with an embodiment of the present invention;

FIG. 4 is a conceptual diagram showing an integrated 3-D space datum according to the views of a multi-view image in accordance with an embodiment of the present invention;

FIG. 5 is a conceptual diagram showing an integrated 3-D space datum calculated from the multi-view image and the depth image of FIG. 2 in accordance with an embodiment of the present invention;

FIG. 6 is a conceptual diagram showing a method of generating a hologram using an integrated 3-D space datum as the input in accordance with an embodiment of the present invention; and

FIG. 7 is a flowchart illustrating a process of generating a digital hologram based on a multi-view image in accordance with an embodiment of the present invention.

FIG. 8 is a conceptual diagram of computer system generating a digital hologram based on a multi-view image in accordance with an embodiment of the present invention.

### DETAILED DESCRIPTION OF THE EMBODIMENTS

Hereinafter, embodiments of the present invention are described in detail with reference to the accompanying drawings. In describing the embodiments of the present invention, a detailed description of related known elements or functions will be omitted if it is deemed to make the gist of the present invention unnecessarily vague.

In this specification, when it is said that one element is ‘connected’ or ‘coupled’ with the other element, it may mean that the one element may be directly connected or coupled with the other element and a third element may be ‘connected’ or ‘coupled’ between the two elements. Furthermore, in this specification, when it is said that a specific element is ‘included’, it may mean that elements other than the specific element are not excluded and that additional elements may be included in the embodiments of the present invention or the scope of the technical spirit of the present invention.

Terms, such as the first and the second, may be used to describe various elements, but the elements are not restricted by the terms. The terms are used to only distinguish one element from the other element. For example, a first element may be named as a second element without departing from the scope of the present invention. Likewise, a second element may be named as a first element.

Furthermore, element units described in the embodiments of the present invention are independently shown in order to indicate different characteristic functions, and it does not mean that each of the element units is formed of a piece of separated hardware or a piece of software. That is, the element units are arranged and included for convenience of description, and at least two of the element units may form one element unit or one element may be divided into a plurality of element units and the plurality of element units may perform functions. An embodiment into which elements are integrated or an embodiment from which some elements are separated is included in the scope of the present invention unless it does not depart from the essence of the present invention.

Furthermore, in the present invention, some elements are not essential elements for performing essential functions, but may be optional elements for improving only performance. The present invention may be implemented using only essential elements for implementing the essence of the present invention other than elements used to improve only performance, and a structure including only essential elements other than optional elements used to improve only performance is included in the scope of the present invention.

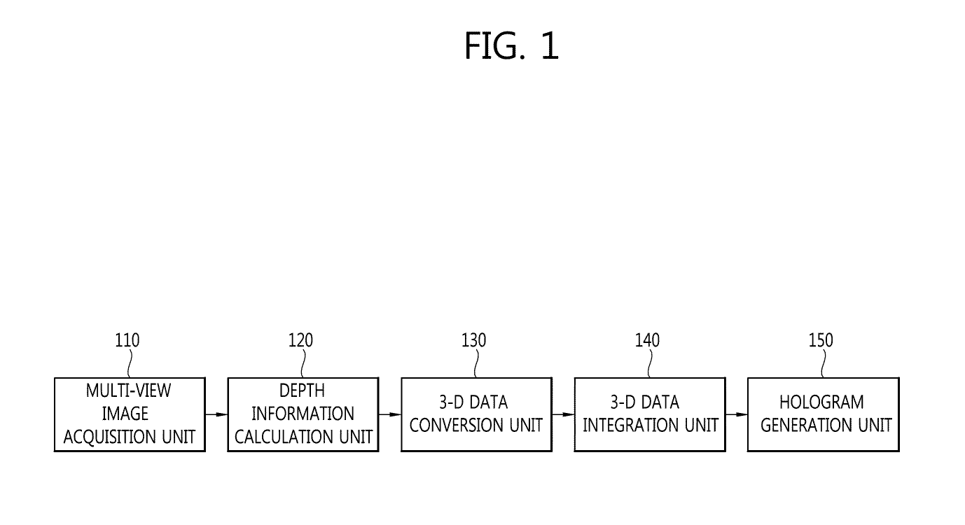

FIG. 1 is a block diagram showing an apparatus for generating a digital hologram based on a multi-view image in accordance with a preferred embodiment of the present invention.

Referring to FIG. 1, the apparatus for generating a digital hologram based on a multi-view image 100 includes a multi-view image acquisition unit 110, a depth information calculation unit 120, a 3-D data conversion unit 130, a 3-D data integration unit 140, and a hologram generation unit 150.

The element units are classified depending on their functions and are used to represent the apparatus for generating a digital hologram based on a multi-view image in accordance with an embodiment of the present invention.

One element unit may be classified into a plurality of element units or a plurality of element units may be integrated into one element unit depending on embodiments, and the embodiments are also included in the scope of the present invention.

The multi-view image acquisition unit 110 can obtain a multi-view image having 3 views or more in real time or receive a previously obtained multi-view image. The multi-view image can be obtained by a multi-view camera system having, for example, a parallel type or convergence type arrangement. In order to capture a 3-D image, two or more cameras must be disposed in a space. In a parallel type arrangement scheme, that is, one of common camera arrangements methods, cameras are disposed in parallel in order to capture a multi-view image. The parallel type arrangement scheme is advantageous in that a target scene can be photographed relatively widely and disparity information representing the depth of an object can be easily obtained. Another camera arrangement scheme includes the convergence type arrangement scheme. In the convergence type arrangement scheme, cameras are disposed so that the optical axis of the cameras converges on a specific point within a scene to be photographed. The convergence type arrangement scheme is disadvantageous in that it is difficult to obtain and process disparity information and a relatively narrow area is photographed as compared with the parallel type arrangement scheme, but this method is chiefly used in applications, such as the restoration of a 3D scene, because a detailed part of an object can be photographed. In addition, a variety of methods can be used to generate a hologram. For example, the convergence type arrangement scheme may be used to generate a hologram.

In accordance with an embodiment of the present invention, a depth camera can be additionally used in addition to a multi-view camera system including three or more cameras. Here, the multi-view image acquisition unit 110 can additionally obtain a depth image besides a multi-view image. The depth camera is a camera used to obtain depth information about a target to be photographed and can be a camera for obtaining depth information about a scene or an object to be photographed in order to produce a 3-D image. For example, a depth camera using infrared rays can calculate the time that infrared rays generated from an infrared sensor is taken to be reflected by and returned from an object and calculate the depth of the object based on the calculated time. Depth information may be obtained from images obtained by a multi-view camera using a stereo matching method without using a depth camera. A depth image additionally obtained by a depth camera can be used in the depth information calculation unit 120 as initial data for improving accuracy and speed.

The depth information calculation unit 120 can calculate depth information about each of the views of the multi-view image obtained by the multi-view image acquisition unit 110. The same or different depth information estimation methods may be used depending on the arrangement of cameras. For example, the same or different depth information estimation methods can be used for a multi-view image obtained by a multi-view camera system having a parallel type arrangement and a multi-view image obtained by a multi-view camera system having a convergence type arrangement. For example, a method of estimating depth information from an obtained image may include various methods including a method, such as stereo matching. For example, finally estimated depth information can be calculated by converting disparity information, calculated by applying stereo matching to an obtained image, into depth information using camera parameters, etc. If depth camera information is additionally used in the multi-view image acquisition unit 110, a depth image obtained by a depth camera can be used to improve accuracy and speed.

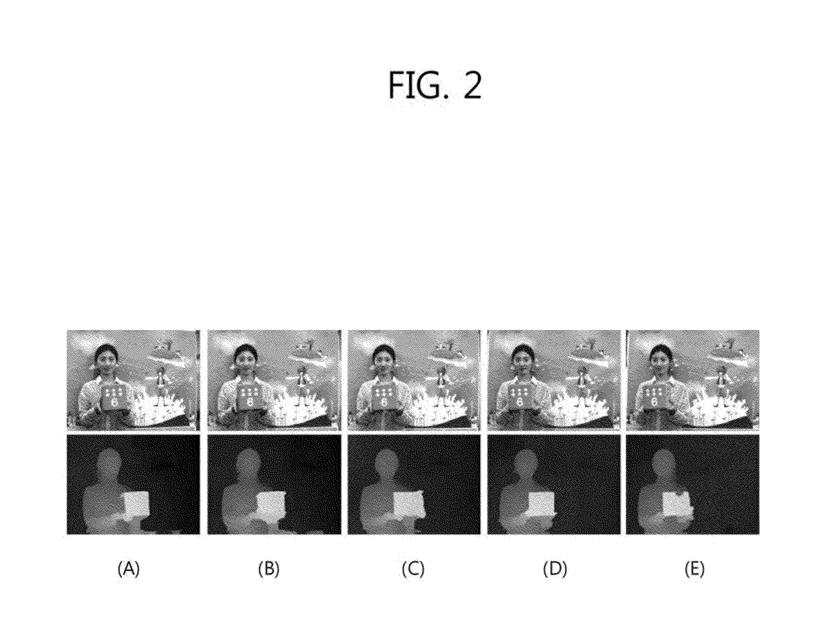

FIG. 2 is a conceptual diagram showing an obtained depth image in accordance with an embodiment of the present invention.

FIG. 2 illustrates resulting images whose depth information has been estimated from 5-view images using a multi-view camera system.

Referring to FIG. 2, a depth image including depth information about each image can be generated based on 5 different views. As described above, an additional depth camera may be used, and information obtained by the depth camera may be used as depth information.

The 3-D data conversion unit 130 can convert depth information about each of the views of the multi-view image calculated by the depth information calculation unit 120 into 3-D space information using camera parameters. The geometric structure of a camera for obtaining an image can be described with reference to a pinhole camera model.

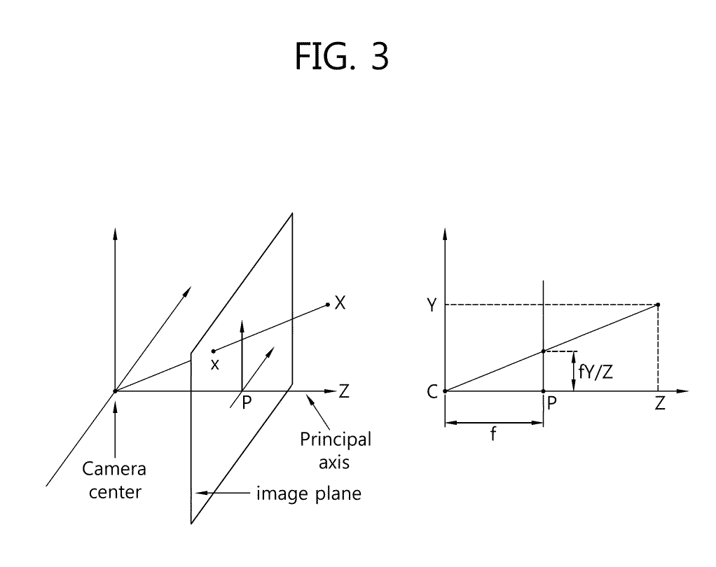

FIG. 3 is a conceptual diagram showing a method of converting 3-D data in accordance with an embodiment of the present invention.

FIG. 3 illustrates the geometric structure of a pinhole camera. World coordinates are projected on an image plane through the pinhole of the camera, and the distance between a camera center and the coordinates projected on the image plane is calculated according to a proportional method.

Referring to the pinhole camera model, the center of projection C and an image plane I are assumed. Here, a point X=(X,Y,Z,1)^{T} that is present on a 3-D space is projected on a point x=(x,y,1)^{T} at which a straight line connected to the center of projection C meets the image plane I. Here, the center of projection C is also called a camera center, a line that has a direction vertical to the image plane and passes through the camera center is called a principal axis, and a point at which the axis meets the image is called a principal point ‘p’. A mapping relationship between the 3-D and the image plane can be represented by the following equation.

Equation 1 below defines a relationship between world coordinates and 2-D coordinates of the projected image of a camera using the camera parameter including focal length, and etc.

$$[ \begin{matrix}x \\ y \\ 1\end{matrix} ] = K [ R \vert T ] [ \begin{matrix}X \\ Y \\ Z \\ 1\end{matrix} ] \qquad [ Equation 1 ]$$

Equation 1 mathematically represents a relationship between 3-D coordinates and 2-D coordinates in a projection matrix using the geometric structure of a pinhole camera. World coordinates can be represented by 2-D coordinates through a projection matrix. Here, the location of projected 2-D coordinates can be determined by camera-intrinsic and -extrinsic parameters. Furthermore, x, y are 2-D coordinates projected within an image plane, K is, a 3×3 matrix, a camera-intrinsic parameter, R is, a 3×3 matrix, a camera-extrinsic parameter for the rotation of the camera, and T is, a 3×1 matrix, a camera-extrinsic parameter for the translation of the camera. Furthermore, X, Y, and Z are coordinates on an actual 3-D space and indicate pieces of information about the width, height, and depth.

In general, depth information about each view, that is, the results of the depth information calculation unit 120, is represented by a depth map. In the depth map, the depth of an object is represented by values of 0-255.

In order to convert the depth information about each view into 3-D space information, the 3-D data conversion unit 130 has to calculate actual 3-D space coordinates X, Y, and Z. Equation 2 below is used in order to calculate Z.

$$Z ( i , j ) = 1.0 / ( \frac{P ( i , j )}{255.0} \times ( \frac{1.0}{Min Z} - \frac{1.0}{Max Z} ) + \frac{1.0}{Max Z} ) \qquad [ Equation 2 ]$$

In Equation 2, Z(i, j) indicates an actual distance between a camera and an object for (i, j) coordinates within an image, and P(i, j) indicates a pixel value for the (i, j) coordinates within the image in a depth map represented by values of 0-255. MinZ and MaxZ indicate a minimum value and a maximum value of the value Z.

In order to convert the depth information about each view into the 3-D space information, the 3-D data conversion unit 130 applies a basic matrix operation to the projection matrix of Equation 1 using Equation 3 below in order to calculate X and Y.

$$\begin{matrix}( \begin{matrix}u \\ v \\ 1\end{matrix} ) = K [ R \vert T ] ( \begin{matrix}X \\ Y \\ Z \\ 1\end{matrix} ) {K}^{- 1} ( \begin{matrix}u \\ v \\ 1\end{matrix} ) - \\ R ( \begin{matrix}X \\ Y \\ Z\end{matrix} ) + T ( \begin{matrix}α \\ β \\ γ\end{matrix} ) \\ = {R}^{T} {K}^{- 1} ( \begin{matrix}u \\ v \\ 1\end{matrix} ) \\ = ( \begin{matrix}X \\ Y \\ Z\end{matrix} ) + {R}^{T} ( \begin{matrix}{t}_{x} \\ {t}_{y} \\ {t}_{z}\end{matrix} )\end{matrix} \\ \frac{α}{γ} = \frac{X + {R}_{1}^{T} {t}_{x}}{Z + {R}_{3}^{T} {t}_{z}} X = \frac{α}{γ} ( Z + {R}_{3}^{T} {t}_{z} ) - {R}_{1}^{T} {t}_{z} \\ \frac{β}{γ} = \frac{Y + {R}_{2}^{T} {t}_{x}}{Z + {R}_{3}^{T} {t}_{z}} Y = \frac{β}{γ} ( Z + {R}_{3}^{T} {t}_{z} ) - {R}_{2}^{T} {t}_{z} \qquad [ Equation 3 ]$$

In Equation 3 α, β, and γ indicate intermediate coefficients in the operation process of the matrix, a subscript T indicates a transposed matrix, and −1 indicates an inverse matrix. The 3-D data calculation method using Equation 3 in the 3-D data conversion unit 130 is one example for calculating 3-D data, and the 3-D data may be calculated using another 3-D data calculation method other than the 3-D data calculation method of Equation 3.

The 3-D data integration unit 140 configures an integrated 3-D space datum for the target object or scene by integrating the pieces of 3-D space information for the each view of the multi-view image, that is, the results of the 3-D data conversion unit 130.

The 3-D data integration unit 140 can integrate the 3-D data, generated at a plurality of the views, into a set of data and send the set of data to the hologram generation unit 140.

The hologram generation unit 140 generates a hologram by using the integrated 3-D space datum, that is, the results of the 3-D data integration unit 140, as the input.

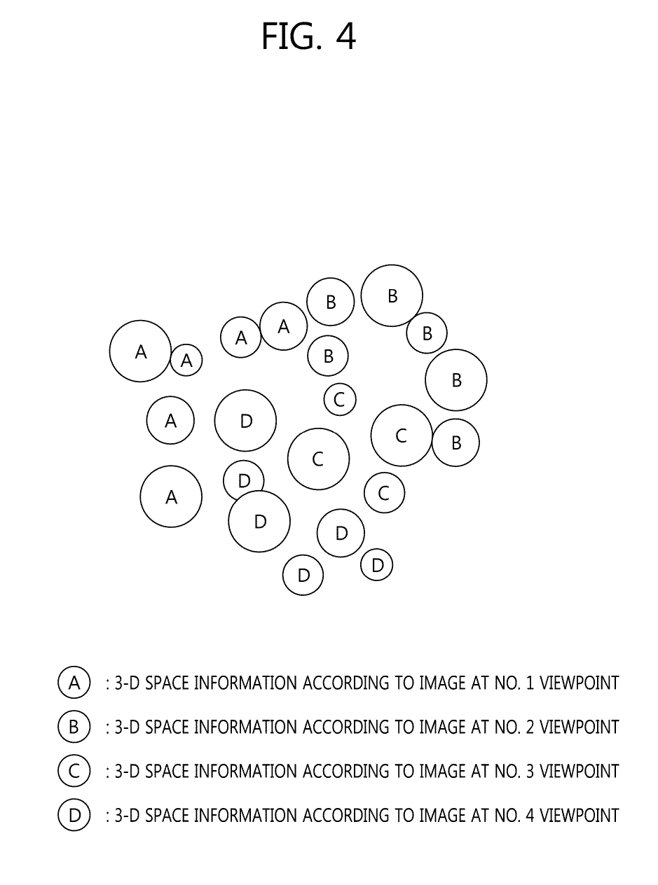

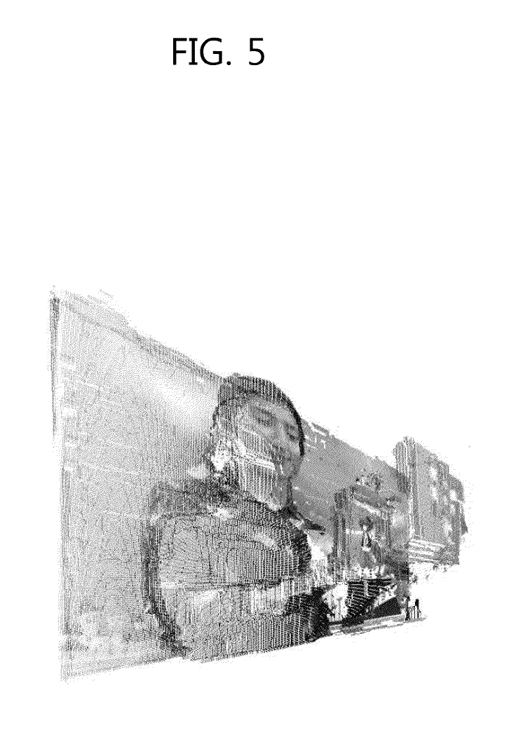

Embodiments of detailed operations of the 3-D data integration unit 140 and the hologram generation unit 140 are described in detail below with reference to FIGS. 4 and 5.

FIG. 4 is a conceptual diagram showing an integrated 3-D space datum according to the views of a multi-view image in accordance with an embodiment of the present invention.

FIG. 4 illustrates a method of configuring an integrated 3-D space datum for a target object or scene by integrating pieces of 3-D space information about respective views.

For example, pieces of 3-D space information obtained at 4 views can be represented by one integrated 3-D space datum. More particularly, in order to configure one integrated 3-D space datum using pieces of 3-D space information obtained at 4 views, the 4 views calculated by the 3-D data conversion unit 130 are integrated, wherein 3-D space information that redundantly appears is deleted. Here, in order to generate a more natural integrated 3-D space datum, 3-D space information may be added to pieces of information obtained from the multi-view image using an interpolation scheme or a curved surface restoration scheme.

The integrated 3-D space datum can be represented in various formats, such as a 3-D point cloud, a Layer Depth Image (LDI), and a 3-D point-sampled video.

FIG. 5 is a conceptual diagram showing an integrated 3-D space datum calculated from the multi-view image and the depth image of FIG. 2 in accordance with an embodiment of the present invention. More particularly, FIG. 5 shows the results of a 3-D point cloud configured by integrating pieces of 3-D space information about respective views that have been obtained at the 5 views of FIG. 2 through the 3-D data conversion unit 130 and then deleting 3-D space information that redundantly appears.

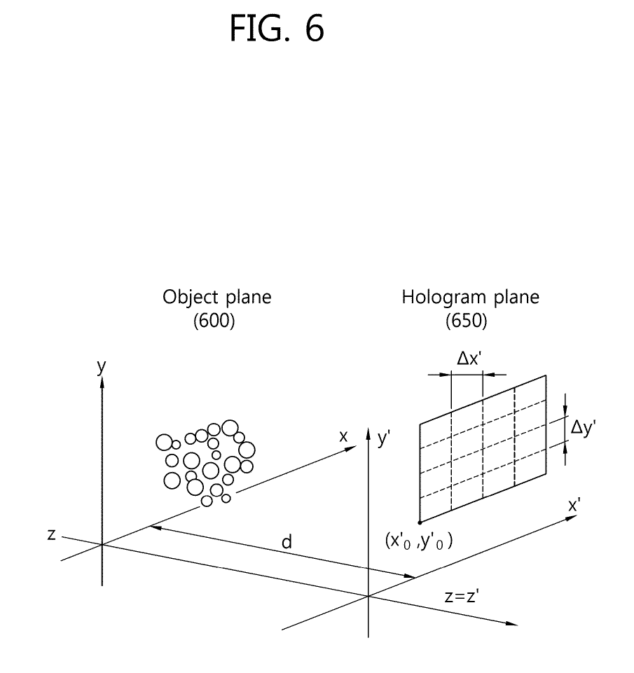

FIG. 6 is a conceptual diagram showing a method of generating a hologram using an integrated 3-D space datum as the input in accordance with an embodiment of the present invention.

Referring to FIG. 6, when light reflected by an integrated 3-D space datum indicating an object point that forms a target object or scene is diffracted by a distance d, the light is transferred to a plurality of pixels located on a hologram plane.

Here, a 3-D object point that form the integrated 3-D space datum has different pixels on a hologram plane that is transferred depending on its location.

Equation 4 below is used to calculate the light intensity for the each pixel on a corresponding hologram plane by taking only object points transferred to the each pixel on the hologram plane, from among object points that form an integrated 3-D space datum, into consideration.

$${I}_{α} = {\sum }_{j ∈ α}^{ N} {A}_{j} cos [ k \sqrt{{( {px}_{α} - {x}_{j} )}^{2} + {( {py}_{α} - {y}_{j} )}^{2} + {z}_{j}^{2}} ] \qquad [ Equation 4 ]$$

In Equation 4, α and j indicate the pixel of a hologram and an object point, k is the wave number of a reference wave and defined as 2π/λ, p is the pixel pitch of the hologram, x_{α} and y_{α} are the coordinates of the hologram, and xⱼ, yⱼ, and zⱼ indicate coordinates of the 3-D object point on the 3-D space. Furthermore, l_{α} indicates the intensity of light of the hologram, and Aⱼ indicates the color component value of the 3-D object point.

The integrated 3-D data can be represented on a hologram based on Equation 4. Equation 4 is one exemplary equation for representing the integrated 3-D data on the hologram. However, another equation may be used to represent the integrated 3-D data on the hologram, which is included in the scope of the present invention.

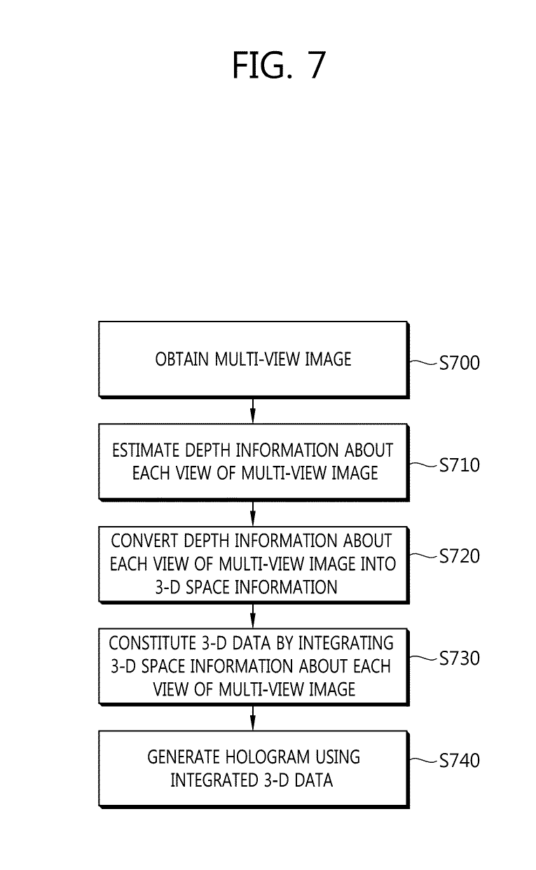

FIG. 7 is a flowchart illustrating a process of generating a digital hologram based on a multi-view image in accordance with an embodiment of the present invention.

Referring to FIG. 7, a multi-view image having 3 views or more is obtained in real time or a previously obtained multi-view image is received at step S700.

In the method of generating a hologram image in accordance with an embodiment of the present invention, a hologram image is generated based on pieces of information about images captured at 3 views or more. At step S700, a depth camera capable of obtaining depth information can be additionally used to extract depth information at step S710.

Depth information about each view of the multi-view image is estimated at step S710.

The depth information about each view of the multi-view image can be calculated using a depth information calculation method based on a multi-view image, such as stereo matching.

The depth information about each view of the multi-view image is converted into 3-D space information using camera parameters at step S720.

As in the operation of the 3-D data conversion unit, for example, pieces of the 3-D space information can be generated using the obtained image information and the camera parameters as input values using the above-described equations.

An integrated 3-D space datum for a target object or scene is configured by integrating the pieces of 3-D space information about the views of the multi-view image at step S730.

The pieces of 3-D space information obtained at step S720 can be integrally represented.

A variety of methods, such as a 3-D point cloud, a Layer Depth Image (LDI), and a 3-D point-sampled video, can be used as a representation method for the integrated 3-D space datum.

A hologram is generated using the integrated 3-D space datum as the input at step S740.

The integrated 3-D space datum can be generated into the hologram using an equation, such as Equation 4.

The steps S710 to S740 may not be necessarily executed as described above. In an actual implementation, the steps may be integrated and executed within a range in which the results of one executed step do not affect the results of the other executed step.

For example, in another embodiment, the steps S720 and S730 may be integrated into one step.

In accordance with the apparatus and method for generating a digital hologram based on a multi-view image according to the present invention, a multi-view image having 3 views or more can be received and depth information about each of the views can be obtained. The obtained color image for each view and the depth image can be converted into 3-D information presented on a 3-D space, one integrated 3-D space datum for a target object or scene can be configured by integrating pieces of the 3-D information about the views, and a digital hologram can be generated using the one integrated 3-D space datum as input data for generating a hologram. If this method is used, a natural 3-D image can be played because a 3-D image corresponding to an observer view is reproduced without a process of generating in-between view images and pieces of corresponding depth information when the observer moves.

Furthermore, in the apparatus and method for generating a digital hologram based on a multi-view image according to the present invention, a multi-view image having 3 views or more is formed of one integrated 3-D space datum not an image for each view and depth information. Accordingly, 3-D restoration for a target object or scene obtained by a multi-view image is possible, the shape of the target object or scene can be easily checked, and data management, such as storage and transmission, is facilitated.

While the invention has been shown and described with respect to the preferred embodiments, it will be understood by those skilled in the art that various changes and modifications may be made without departing from the spirit and scope of the invention as defined in the following claims.

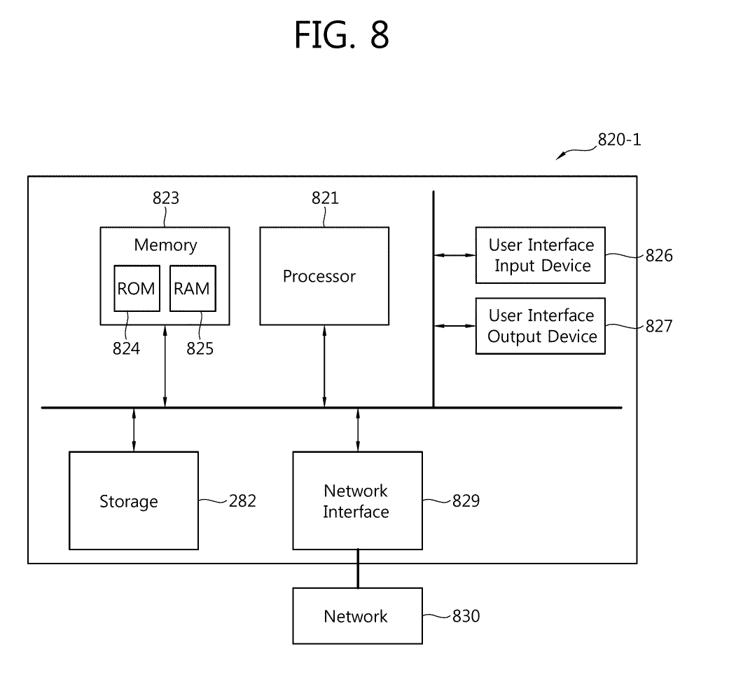

FIG. 8 is a conceptual diagram of computer system generating a digital hologram based on a multi-view image in accordance with an embodiment of the present invention.

An embodiment of the present invention may be implemented in a computer system, e.g., as a computer readable medium. As shown in FIG. 8, a computer system 820-1 may include one or more of a processor 821, a memory 823, a user input device 826, a user output device 827, and a storage 828, each of which communicates through a bus 822. The computer system 820-1 may also include a network interface xx9 that is coupled to a network 830. The processor 821 may be a central processing unit (CPU) or a semiconductor device that executes processing instructions stored in the memory 823 and/or the storage 828. The memory 823 and the storage 828 may include various forms of volatile or non-volatile storage media. For example, the memory may include a read-only memory (ROM) 824 and a random access memory (RAM) 825.

The processor (821) is to implement the embodiments disclosed above based on the computer readable medium. For example, the processor (821) is configured to receive a multi-view image and calculating depth information about an image at each view of the multi-view image, calculate an integrated 3-D space datum based on the multi-view image and the pieces of depth information and generate hologram information from the integrated 3-D space datum.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

What is claimed is:

1. A method of generating a hologram image, comprising:
receiving a multi-view image and calculating depth information about an image at each view of the multi-view image;
calculating an integrated 3-D space datum based on the multi-view image and the pieces of depth information; and
generating hologram information from the integrated 3-D space datum.

2. The method of claim 1, wherein receiving a multi-view image and calculating depth information about an image at each view of the multi-view image comprises:
calculating first image information and first depth information generated at a first viewpoint;
calculating second image information and second depth information generated at a second viewpoint; and
calculating third image information and third depth information generated at a third viewpoint.

3. The method of claim 1, wherein calculating an integrated 3-D space datum based on the multi-view image and the pieces of depth information comprises:
converting the multi-view image into 3-D data for the views based on the pieces of calculated depth information; and
calculating the integrated 3-D space datum that is integrated information of the 3-D data for the respective views.

4. The method of claim 3, wherein converting the multi-view image into 3-D data for the views based on the pieces of calculated depth information is determined by Equation below regarding a relationship between 3-D coordinates and 2-D coordinates projected on an image of a camera.
$$[ \begin{matrix}x \\ y \\ 1\end{matrix} ] = K [ R \vert T ] [ \begin{matrix}X \\ Y \\ Z \\ 1\end{matrix} ] \qquad 〈 Equation 〉$$
wherein x, y are the 2-D coordinates projected within an image plane, K is, a 3×3 matrix, a camera-intrinsic parameter, R is, a 3×3 matrix, a camera-extrinsic parameter for a rotation of the camera, T is, a 3×1 matrix, a camera-extrinsic parameter for a translation of the camera, and X, Y, and Z are coordinates on a 3-D space and indicate pieces of information about a width, height, and depth.

5. The method of claim 1, wherein generating hologram information from the integrated 3-D space datum is performed by Equation below.
$${I}_{α} = {\sum }_{j ∈ α}^{ N} {A}_{j} cos [ k \sqrt{{( {px}_{α} - {x}_{j} )}^{2} + {( {py}_{α} - {y}_{j} )}^{2} + {z}_{j}^{2}} ] \qquad 〈 Equation 〉$$
wherein α is a pixel of a hologram, j is a 3-D object point, k is a wave number of a reference wave and defined as 2π/λ, p is a pixel pitch of a hologram, x_{α} and y_{α} are coordinates of the hologram, xⱼ, yⱼ, and zⱼ indicate coordinates on a 3-D space of the 3-D object point, l_{α} indicates an intensity of light of the hologram, and Aⱼ indicates a color component value of the 3-D object point.

6. The method of claim 1, further comprising calculating depth information using a depth camera.

7. An apparatus for generating a hologram image, comprising:
a depth information calculation unit configured to receive a multi-view image and calculating depth information about an image at each view of the multi-view image;
a 3-D data integration unit configured to calculate an integrated 3-D space datum based on the multi-view image and the pieces of depth information; and
a hologram generation unit configured to generate hologram information from the integrated 3-D space datum.

8. The apparatus of claim 7, further comprising a multi-view image acquisition unit configured to obtain pieces of image information generated at a first viewpoint, a second viewpoint, and a third viewpoint,
wherein the depth information calculation unit is configured to calculate first image information and first depth information generated at the first viewpoint, calculate second image information and second depth information generated at the second viewpoint, and calculate third image information and third depth information generated at the third viewpoint.

9. The apparatus of claim 7, further comprising a 3-D data conversion unit configured to convert the multi-view image into 3-D data for the views based on the pieces of calculated depth information,
wherein the 3-D data integration unit is configured to calculate the integrated 3-D space datum that is integrated information of the 3-D data for the respective views.

10. The apparatus of claim 9, wherein the 3-D data conversion unit converts the multi-view image into 3-D data for the views based on the pieces of calculated depth information according to Equation below regarding a relationship between 3-D coordinates and 2-D coordinates projected on an image of a camera.
$$[ \begin{matrix}x \\ y \\ 1\end{matrix} ] = K [ R \vert T ] [ \begin{matrix}X \\ Y \\ Z \\ 1\end{matrix} ] \qquad 〈 Equation 〉$$
wherein x, y are the 2-D coordinates projected within an image plane, K is, a 3×3 matrix, a camera-intrinsic parameter, R is, a 3×3 matrix, a camera-extrinsic parameter for a rotation of the camera, T is, a 3×1 matrix, a camera-extrinsic parameter for a translation of the camera, and X, Y, and Z are coordinates on a 3-D space and indicate pieces of information about a width, height, and depth.

11. The apparatus of claim 7, wherein the hologram generation unit is configured to generate hologram information from the integrated 3-D space datum according to Equation below.
$${I}_{α} = {\sum }_{j ∈ α}^{ N} {A}_{j} cos [ k \sqrt{{( {px}_{α} - {x}_{j} )}^{2} + {( {py}_{α} - {y}_{j} )}^{2} + {z}_{j}^{2}} ] \qquad 〈 Equation 〉$$
wherein α is a pixel of a hologram, j is a 3-D object point, k is a wave number of a reference wave and defined as 2π/λ, p is a pixel pitch of a hologram, x_{α} and y_{α} are coordinates of the hologram, xⱼ, yⱼ, and zⱼ indicate coordinates on a 3-D space of the 3-D object point, l_{α} indicates an intensity of light of the hologram, and Aⱼ indicates a color component value of the 3-D object point.

12. The apparatus of claim 7, wherein the depth information is a value calculated using depth camera.
